(19) United States
(12) Patent Application Publication
(10) Pub. No.: US 2007/0295168 A1
(43) Pub. Date: Dec. 27, 2007

(54) Hotel entry door handle release hook

(76) Inventor: Paul Curtis Singleton, Las Vegas, NV (US)

Correspondence Address: PAUL CURTIS SINGLETON, 4270 CARMINE ST., LAS VEGAS, NV, 89122, US

(21) Appl. No.: 11/810,983

(22) Filed: Jun. 8, 2007

Related U.S. Application Data
(60) Provisional application No. 60/805,592, filed on Jun. 22, 2006.

(51) Int. Cl. E05B 19/20

(52) U.S. Cl. 81/15.9

(57) ABSTRACT

This device opens hotel entry doors, when the electronic card key lock malfunctions. Its intended use is to gain immediate entry (without damage) when card keys are lost, during medical emergencies, when lithium batteries are dead, and will not take a charge from an external device, or when the lock mechanically malfunctions. Or when drilling out an expensive lock, only to replace it with another expensive lock, or drilling on a hotel entry door lock @ midnight, or three in the morning is not an option. Also works on service doors.

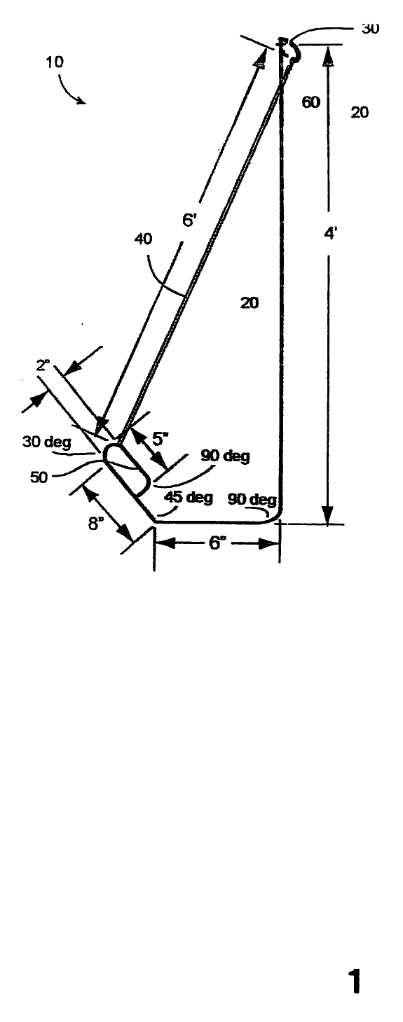

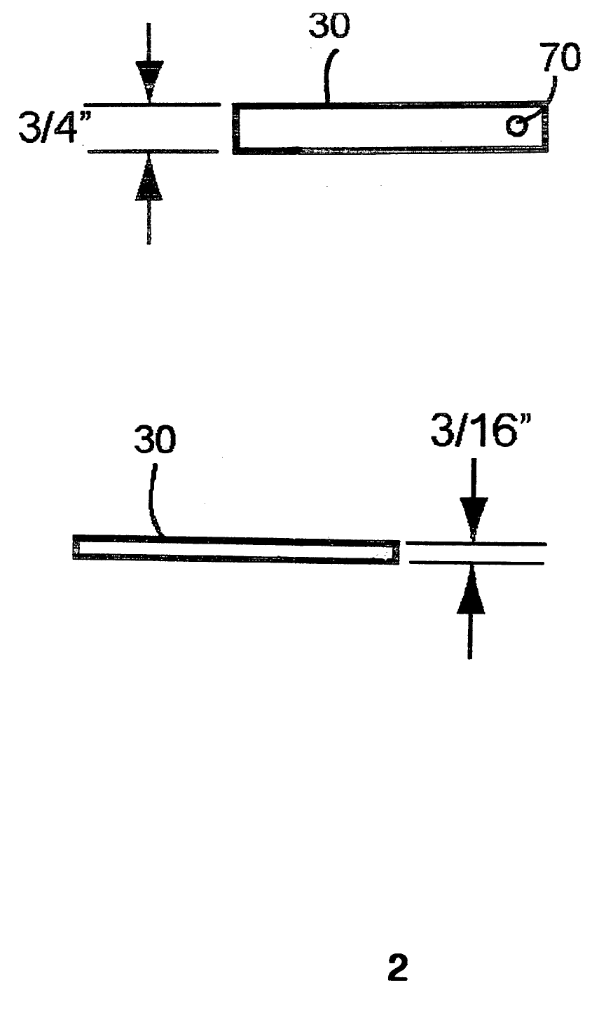

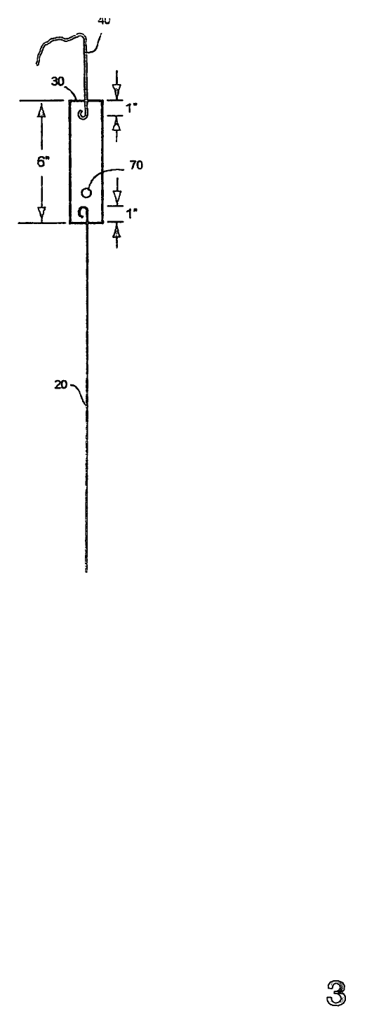

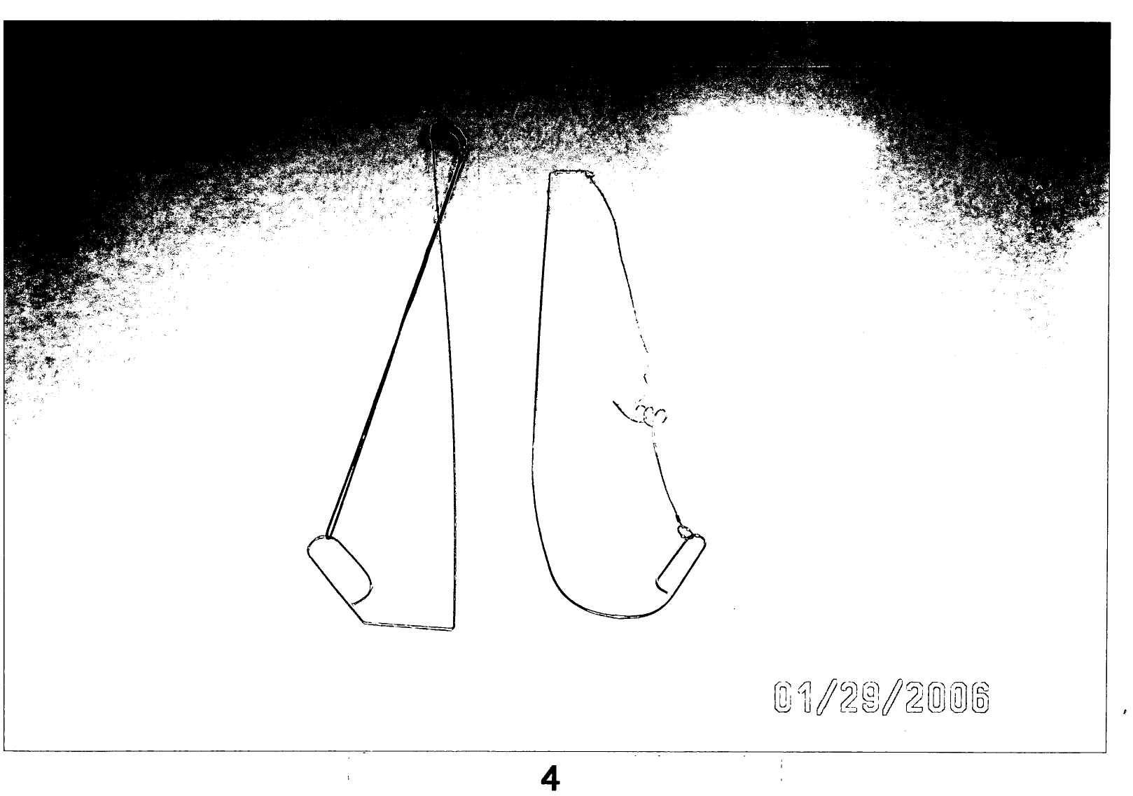

The following components are all joined together (Vulcanized) in order to form one single hotel door entry release hook, unit:

6 ft. ⅛″ round diameter stainless steel rod (316 grade).

One flat rubber bungee strap, 6″L×¾″W× 3/16″H.

Next component is 6′×⅛″ Nylon parachute cord, consisting of seven strands of intertwined nylon, covered with a nylon sleeve (550 lbs. tensile strength)

And the last item is a 1″ “S” hook, used to hold the cord to the unit when transporting.

In operation, each component enhances the operation of the next component.

The stainless steels flexoral, and tensil strength enhances the function of the bungee strap when it wraps around the inside entry door handle, which is done by pulling the bungee cord portion on the outside of the door. Using the very best quality components, joined by vulcanization, makes the unit extremely durable, allowing the unit to maintain its proper shape, and operational function. This device works on all Hotel/Casino entry doors, and security type door handles. See attached photos.

One component, the rubber strap, with its attached bungee cord, is slid underneath the hotel entry door, with the assistance of the ⅛″ stainless rod. The rod is then pulled up against the door, to be used as a guide. The unit is then positioned from the outside of the door, on the opposite side of the door. Since the rod, or tool is positioned up against the door vertically, simply allow the rod to drop across onto the shaft of the inside door handle. Since the attached rubber bungee strap is naturally drooping over the inside door handle, with its attached nylon cord, and the other end of the cord is still on the outside of the door, simply pull the cord from the outside, and the inside door handle depresses down, opening the door. Very easy to operate, exact precision is not required. Training a locksmith or Engineer only requires a few minutes.

Used by Locksmith's, Police and Fire Departments, to gain immediate access into hotel entry doors, within 30-60 seconds without Damage.

Designed to be used or, Hotel electronic card key door handles, and service door handles.

Ideally used when the lock lithium batteries expire, lock malfunctions, lost card keys, and medical emergencies.

### INTRODUCTION

Las Vegas currently has 185,000 Hotel rooms, and more are under construction.

Consider how many hotel rooms there are nationally, and how many hotel rooms World Wide?

The majority of these hotel entry door locks are electronic card key handle locks.

Price range averages $700.00 to $1,500.00.

The Hotel entry door handle release hook can open all these entry door locks.

Each Hotel currently purchases a similar device, sold by Locksmith supply companies. Due to the poor design, this device does not work.

The supply company knows it does not work, and upon purchase, the locksmith at each property learns that this device does not work. However, once sold, the profit has been made.

The Hotel entry door handle release hook, has been field tested, and the design perfected, for fifteen years at four major Las Vegas Strip Hotels/Casinos.

Potential sales to supply companies, Hotels, and municipalities is promising.

However, consider a much larger concept, one that requires only one presentation, to one target, the lock manufacturers association.

The Hotel door handle release hook has even greater financial potential. Because of its effectiveness, the design of this device threatens the very existence of the multibillion dollar lock manufacturing industry.

Even more horrifying, is if the design fell into the wrong hands. The hotel industry might as well take the entry doors off.

During the early 1970's a device was invented, and sold exclusively to locksmith's and municipalities. It was used to gain entry into locked cars. The slim jim became a very valuable, and profitable tool. However, once the simplicity of the design became known to criminals, it became the largest nemesis of the auto, and insurance industries to this day.

In retrospect, these industries would have gladly purchased, and moth balled this device. Most recently, portable heart defibrillators were considered too expensive at $5000, until the first lawsuits. Now, most hotels have purchased them.

Consider the potential liability of a Hotel not purchasing this device.

Please refer to the attached figure description, number description list, and the drawings, and/or photos.

Specific measurements, and/or materials referred to are intended as a visual aid only, and are provided primarily to aid in one possible manufacturing scenario. The same or a similar tool can be constructed with a multitude of materials of various sizes, and shapes, joined together by several different methods. For example, the rod #20 can be fashioned from various round, square, or flat stock, of different lengths, and diameters. Such as stainless steel, aluminum, iron, steel, copper, or plastic composites. The hole #70 in the bungee strap is intended as an efficient means of transport for #40 the 6′ ft. nylon parachute cord, and to assist in shaping the rubber strap #30. The cord #40 can also be of different lengths, or materials.

Such as nylon string, various types of rope like materials, cords, and various metal cables. The “S” hook #60 is placed into the rubber bungee strap #30 through the ¼ inch diameter hole #70 (optional) in the bungee strap #30 for the purpose of transport, and to aid in the shaping of the rubber bungee strap #30. The “S” hook #60 may be replaced with other materials, such as various metal rings, snap hooks of various sizes, and shapes.

Therefore, more or less material can be used with each component. The components of the hotel entry door handle release hook are joined together by vulcanization, for the purpose of strength, durability, sleekness, and unobtrusiveness. However, other means of joining the components can also be used. Such as liquid rubbers, glues, composite plastics, sewing, or various encasements, such as heat shrink tubing.

What distinguishes the hotel entry door handle release hook from the current “art” and/or model? The current model wire gauge is too large at 3/16th of an inch in diameter to be slid over a doorway thresh hold, and under the entry doors drop down fire stop, without damaging the door. This larger diameter rod therefore lacks the flexoral ability to snap back to its original shape, and continue to perform its intended function. Opening entry doors. Therefore, the larger, lower quality rod is prone to breakage. The current models top handle faces the opposite (Wrong) direction. Because this pull down handle is metal, it slides off the metal entry door handle, which it is attempting to pull down, to open the door.

The alignment of the current model is very difficult at best, because this pull down handle is supposed to be aligned above, and on the outside of the interior door handle, manipulated from the outside or exterior of the entry door.

Alignment becomes a matter of chance, rather than training or skill. Especially because the operator is %working blindly on the other side of the entry door (exterior). In contrast, the new hotel entry door handle release hook uses its unique, smaller, stronger rod #20 as a guide to drop across, and over onto the inside door handle shaft. Precision is not required.

The new models dry bungee strap #30 naturally droops over the interior door handle from the inside of the interior door handle shaft, and outward over the Interior door handle. When the bungee strap #30 is pulled down with the attached parachute cord #40 from the exterior of the entry door, the dry rubber bungee strap #30 wraps around the inside door handle, pulling the handle down, opening the entry door. The process is completed by the operator on the exterior of the entry door, by simply applying light pressure against the door with one hand, and pulling the remaining parachute cord #40 outward, with the other hand. Thus pulling the interior door handle downward, and depressing the door latches, and/or deadbolt. The uniqueness of this new model can easily be observed in the attached side by side comparison photos.

Not to mention, this new device always works, apposed to the current model, which rarely, if ever, works.

What is claimed is:

1. The hotel entry door handle release hook, slides under the door, pulls the interior door handle down, opening the door.
